(19) United States
(12) Patent Application Publication
(10) Pub. No.: US 2011/0154208 A1
(43) Pub. Date: Jun. 23, 2011

(54) METHOD AND APPARATUS FOR UTILIZING COMMUNICATION HISTORY

(75) Inventor: Hiroshi HORII, Palo Alto, CA (US)

(73) Assignee: Nokia Corporation, Espoo (FI)

(21) Appl. No.: 12/641,913

(22) Filed: Dec. 18, 2009

(51) Int. Cl. G06F 15/173; G06F 3/01; G06F 3/048

(52) U.S. Cl. 715/736; 709/224; 715/848

(57) ABSTRACT

An approach is provided for presenting a communication history. The communication widget collects context information on one or more communication sessions between a first party and a second party from a plurality of applications, services, devices, or a combination thereof. Then, the communication widget aggregates the context information into a communication history. Next, the communication widget identifies one or more communication parameters in the context information, wherein the communication parameters relate to performing the communication sessions. Next, the communication widget determines a frequency or a success rate of each of the identified communication parameters in the communication history.

### BACKGROUND

Modern communication technology has been developed and diversified to such an extent that users can easily switch among various forms of communication (e.g., telephone, text messaging, e-mail, social networking services, etc.). These communications may be performed, for instance, using a single device or any number of devices (e.g., mobile phones, home phones, work phones, computers, Internet tablets, etc.). However, the easy availability of such diverse forms of communications has also made it apparent that there is a need to keep a record of past communications across various forms of communication and devices in order to help a user make more effective use of available communication technologies. Conventionally, an overview of a communication history may be stored in a device, showing past communications between the device and any other communicating parties using various forms of communication. However, this does not provide detailed communication history between the device and a specific party. Further, a user of the device may sometimes miss an incoming communication, and may forget or may not know the best way to return the missed communication. Therefore, service providers and device manufacturers face significant technical challenges to providing a comprehensive communication history with detailed information between the communicating parties.

### SOME EXAMPLE EMBODIMENTS

Therefore, there is a need for an approach for forming a comprehensive communication history and effectively presenting the communication history.

According to one embodiment, a method comprises collecting context information on one or more communication sessions between a first party and a second party from a plurality of applications, services, devices, or a combination thereof. The method also comprises aggregating the context information into a communication history. The method further comprises identifying one or more communication parameters in the context information, wherein the communication parameters relate to performing the communication sessions. The method further comprises determining a frequency or a success rate of each of the identified communication parameters in the communication history.

According to another embodiment, an apparatus comprising at least one processor, and at least one memory including computer program code, the at least one memory and the computer program code configured to, with the at least one processor, cause, at least in part, the apparatus to collect context information on one or more communication sessions between a first party and a second party from a plurality of applications, services, devices, or a combination thereof. The apparatus is also caused to aggregate the context information into a communication history. The apparatus is further caused to identify one or more communication parameters in the context information, wherein the communication parameters relate to performing the communication sessions. The apparatus is further caused to determine a frequency or a success rate of each of the identified communication parameters in the communication history.

According to another embodiment, a computer-readable storage medium carrying one or more sequences of one or more instructions which, when executed by one or more processors, cause, at least in part, an apparatus to collect context information on one or more communication sessions between a first party and a second party from a plurality of applications, services, devices, or a combination thereof. The apparatus is also caused to aggregate the context information into a communication history. The apparatus is further caused to identify one or more communication parameters in the context information, wherein the communication parameters relate to performing the communication sessions. The apparatus is further caused to determine a frequency or a success rate of each of the identified communication parameters in the communication history.

According to another embodiment, an apparatus comprises means for collecting context information on one or more communication sessions between a first party and a second party from a plurality of applications, services, devices, or a combination thereof. The apparatus also comprises means for aggregating the context information into a communication history. The apparatus further comprises means for identifying one or more communication parameters in the context information, wherein the communication parameters relate to performing the communication sessions. The apparatus further comprises means for determining a frequency or a success rate of each of the identified communication parameters in the communication history.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting a communication history, according to one embodiment;

FIG. 2 is a diagram of the components of the communication widget, according to one embodiment;

FIG. 3 is a flowchart of a process for presenting a communication history, according to one embodiment;

FIG. 4 is a flowchart of a process for recommending a communication parameter, according to one embodiment;

FIG. 5 is a flowchart of a process for displaying a communication history and other related information on a screen, according to one embodiment;

FIG. 6 is a flowchart of a process for scrolling a timeline of a communication history on a screen, according to one embodiment;

FIGS. 7A-7C are diagrams of a user interface utilized in the processes of FIG. 3, according to one embodiment;

FIG. 8 is a diagram of a user interface utilized in the processes of FIG. 3, according to another embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for presenting a communication history are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

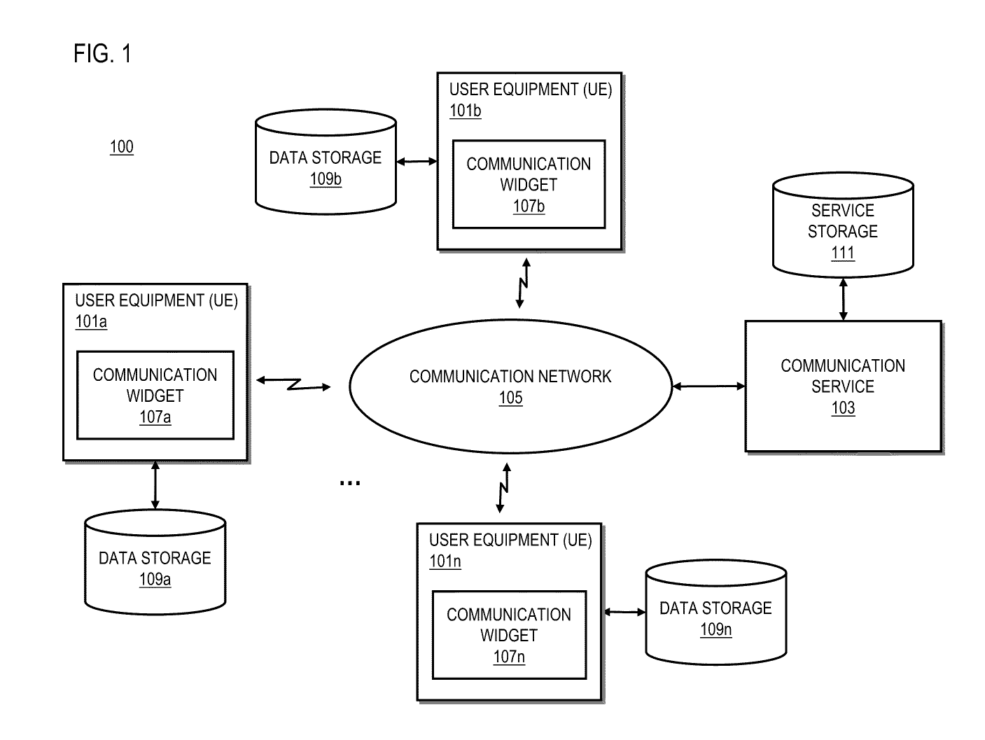

FIG. 1 is a diagram of a system capable of presenting a communication history, according to one embodiment. As noted previously, modern communication systems provide users with a large and diverse range of communication options including, for example, telephone calls, e-mails, text messages, instant messages, and other like forms of communication. As an added layer of complexity, even within the same form of communication (or communication type), there may be different methods for communicating with or by any particular user including multiple phone numbers (e.g., home, work, cell, etc.), addresses (e.g., work e-mail, personal e-mail, etc.), services (e.g., Facebook, MySpace, etc.), and the like. For example, in a telephone communication, a user may choose to call using either a home phone number or a mobile phone number. As another example, in an email communication, the user may have a work e-mail address and a personal e-mail address. In addition, communication methods may involve a private communication such as phone calls, e-mails or text messages, wherein the communication is directed to one or more parties. The communication methods may also involve public or semi-public communication such as status update on a social networking website such as Facebook or Twitter, wherein the recipient of the communication may be anyone on the network depending on a user setting. Accordingly, users now routinely rely on any number of communication services to perform daily tasks or business activities. At the same time, the flood of communications also makes it easier for users to miss or fail to respond to communications.

Further, with development of hardware technology, many of the modern communication devices can handle multiple forms of communication along with various other tasks within a single device. By way of example, when operating multiple functions or tasks on a single device, the user may not be able to respond to an incoming communication due to various reasons such as being occupied with other tasks on the mobile device (e.g., playing movies or games). In other cases, the user may simply miss a communication and then forget to respond or follow up on the missed communication. Further, with multiple forms of communication in one device, the user may not be able to answer a phone call while he is trying to answer an urgent text message, for example. Therefore, in addition to a history of successful communications, there is a need for a structured way to keep a record of missed or unanswered communications. Conventionally, mobile devices can keep a history of multiple forms of communication, and the history can have information such as time of the communication or the information about the communication such as phone numbers or names of a communicating party. However, this history can be spread across multiple services and devices depending on the forms of communication used by a particular user. As a result, it is often extremely difficult or burdensome for a user to obtain a complete record or history of communication between parties when multiple forms of communications are used.

To address this problem, a system 100 of FIG. 1 introduces the following capabilities: (1) to collect context information on various communication sessions between parties, (2) aggregate the collected context information into a common communication history, (3) identify the communication parameters (e.g., communication type, communication address, location, time, status, schedule, subject, communication party, etc.) in the context information, and (4) recommending a method of communication or communication parameters for establishing a new communication based on the communication history and related information. In particular, the system 100 enables collection of various information about the communication sessions to form a comprehensive communication history between parties including information about the communication sessions. By analyzing the history, the system 100 can then recommending a method of communication (i.e. communication parameters) if communication is desired and/or present a user interface for depicting the collected communication history to the user. The recommendation of a method of communication is based on various factors including a frequency or a success rate for conducting a communication session using each of the communication parameters identified in the communication history. For example, one communication parameter may be communication type. In this case, the system 100 may detect from the communication history that the user is most successful at reaching a friend by calling the friend at the friend's home number between 7 pm and 10 pm in the evening. Accordingly, the system 100 can recommend to the user the communication parameters (e.g., communication type=phone call, time=7 pm to 10 pm, etc.) that is most likely to succeed in reaching the friend. The system 100 also allows placing various communication sessions into categories based on the communication parameters, and displaying past communication sessions (i.e. communication history) according to the categories, along a timeline, wherein the timeline is a visual representation of a time period between two points in time. The display of the communication history according to the category is preferably presented as three-dimensional representation and/or animation.

As shown in FIG. 1, the system 100 comprises user equipment (UEs) 101a-101n having connectivity to one another as well as to the communication service 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.). The UE 101 also includes or is connected to a data storage medium 109 to store communication history data and/or to access the stored data.

The UE 101 may include a communication widget 107. The communication widget 107 is capable of handling various communication operations using the forms of communicating available at the UE 101. For example, the communication widget 107 may manage incoming or outgoing communications via the UE 101, and display such communication as they are received or processed. In certain embodiments, the communication widget 107 may also provide visualization (e.g. graphical user interface) to allow a user to control communication over the communication network 105 using any available form of communication or view a history of such communications. For example, the communication widget 107 may include an option to select communication with the UEs 101a-101n. Further, the communication widget 107 may include interfaces that allow the user to communicate with any Internet-based websites or to use e-mail services via the communication service 103. For example, the communication widget 107 may include visual interfaces to access Internet and/or to send and receive e-mails. The communication widget 107 may also include visual interfaces to display information from the data files on the list, such as popularity ratings, access history, size of the file, a time of creation of the file, etc. In addition, the communication widget 107 may also include interfaces to interact with social network services. The communication widget 107 may communicate with the data storage medium 109 to access or store communication history data. Further, the communication widget 107 may also communicate with another UE 101 or a communication service 103.

Further, the communication widget 107 may collect communication history data and then perform tasks using the collected data. For example, the communication widget 107 may keep a record of communication sessions and any related context or other information such as successfulness of the communication, time of the communication session, a form of communication used for the communication session, etc. Each communication session may involve a phone call, an email message, a text message, or any other attempted or successful communication. In one embodiment, the communication widget 107 collects this context information to form a communication history. The context information about the communication session may be recorded at the time of initiation of a communication, at the end of the communication, or at any time during the communication. This information may be stored in the data storage medium 109 or the service storage medium 111. The accumulated information and the communication history may be used by the communication widget 107 to recommend a method of communication to contact a party and/or present a representation of a communication history covering multiple forms of communication. Alternatively, the computation for recommending a method of communication or presenting the communication history may also be performed in the communication service 103, and the result of the computation may be sent to the UE 101. In some embodiments, the communication widget 107 may communicate with a three-dimensional rendering software and hardware to display the communication history in a three-dimensional visualization.

The communication service 103 provides various services related to communication to the UEs 101a-101n, such that the UEs 101a-101n can communicate with each other over the communication network. The services provided by the communication service 103 may include a cellular phone service, internet service, data transfer service, etc. The communication service 103 may also provide content such as music, videos, television services, etc. The communication service 103 may be connected to a service storage medium 111 to store or access data. The communication service 103 is also able to perform various computations, some of which are performed for the UE 101. For example, the UE 101 may send information about a user's communication with other users to the communication service 103, and the communication service 103 may compute the user's communication trend and send the result back to the UE 101.

By way of example, the UEs 101s and the communication service 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

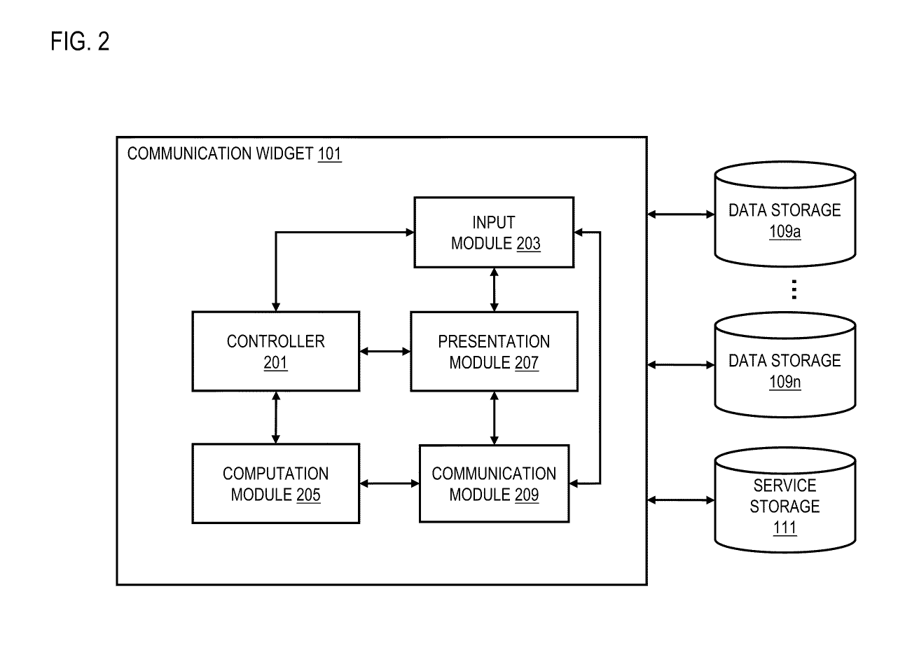

FIG. 2 is a diagram of the components of the communication widget 107, according to one embodiment. By way of example, the communication widget 107 includes one or more components for presenting a communication history. It is contemplated that the functions of these components may be combined in one or more components or performed by other components of equivalent functionality. In this embodiment, the communication widget 107 includes a controller 201, an input module 203, a computation module 205, a presentation module 207 and a communication module 209. The controller 201 oversees tasks, including tasks performed by the input module 203, the computation module 205, the presentation module 207 and the communication module 209. The input module 203 manages and communicates inputs for controlling the communication functions of the communication widget 107 and/or the UE 101. The input may be in various forms including pressing a button on the UE 101, touching a touch screen, scrolling through a dial or a pad, etc. The computation module 205 performs various computations and estimations based on the collected context information, including forming a communication history using information about past communication sessions, and recommending a method of communication based on the information. The presentation module 207 controls display of a user interface such as graphical user interface, to convey information and to allow user to interact with the UE 101 via the interface. Further, the presentation module 207 interacts with the controller 201, the input module 203 and the communication module 209 to display any information generated during their operation (e.g., conveying context information, communication history, or recommended communication parameters). The communication module 209 manages and controls any incoming and outgoing communication such as telephone calls, text messaging, instant messaging, Internet communications (e.g., Voice over Internet Protocol (VoIP), social networking messages, etc.). The UE 101 may also be connected to storage media such as the data storage media 109a-109n such that the communication widget 101 can access or store communication history data. By way of example, if the data storage media 109a-109n are not local, then they may be accessed via the communication network 105. The UE 101 may also be connected to the service storage 111 via the communication network 105 such that the communication widget 107 may be able to manage or access the communication history data in the service storage medium 111. For example, the communication widget 107 can store information on the frequency or success rate of communication sessions with respect to each communication parameter.

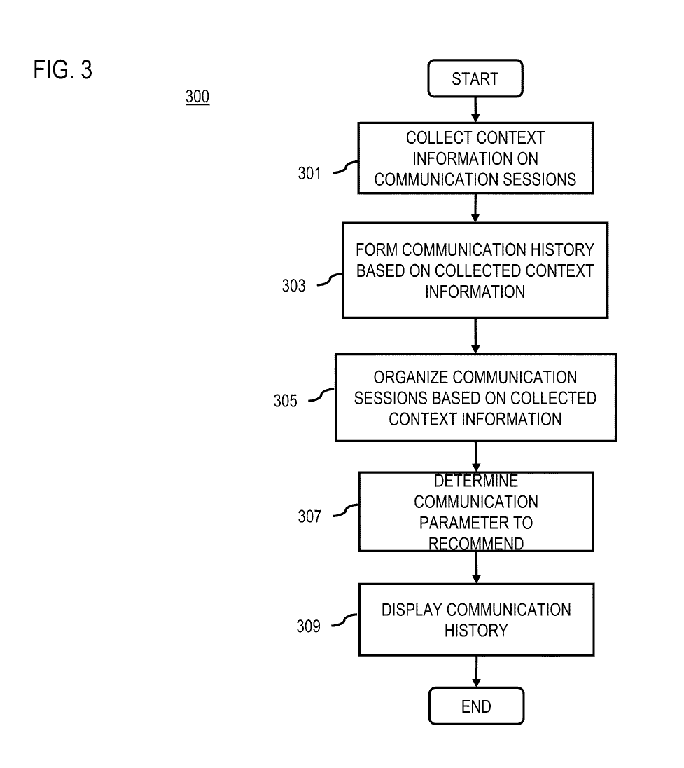

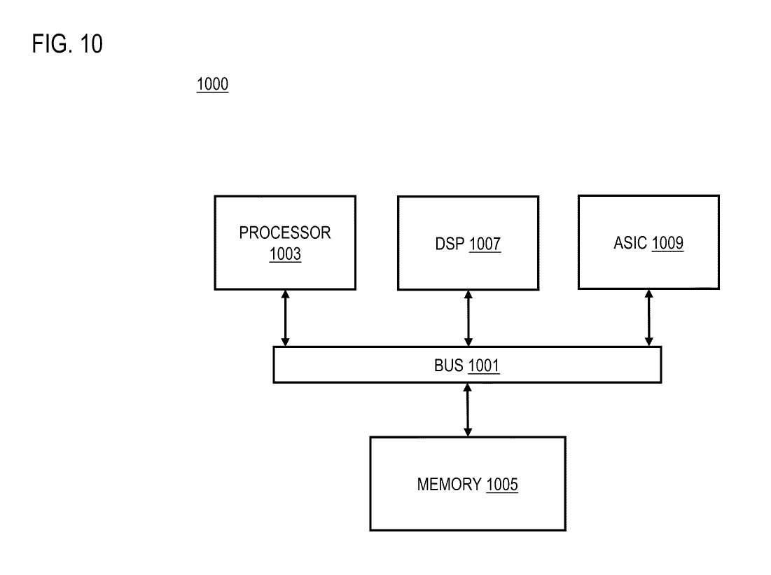

FIG. 3 is a flowchart of a process for presenting a communication history, according to one embodiment. In one embodiment, the communication widget 107 performs the process 300 and is implemented in, for instance, a chip set including a processor and a memory as shown FIG. 10. In step 301, the communication widget 107 collects context information on communication sessions between communicating parties. This context information may be available in the UE 101, the communication service 103, the data storage medium 109, the service storage medium 111, or other similar data repository. In one embodiment, the context information may include communication parameters related to performing the communication sessions such as communication type, communication address, communication party, time, location, status, and subject. In step 303, a communication history is formed based on the collected context information. More specifically, the communication widget 107 aggregates information about the communication history of communication sessions by one or more forms of communication or by any of the other communication parameters. In step 305, the communication sessions are organized by identifying the communication parameters associated with corresponding communication sessions (e.g., by parsing or analyzing the context information collected about the communication sessions). For example, the communication widget 107 detects and aggregates context information related to the various communication sessions (e.g., of different time frames and by different communication methods) conducted at the UE 101 with one or more other parties (e.g., individual parties or groups) to form a communication history. Each of the communication session may be linked or associated with one or more communication parameters including a time of the communication session, a method of communication, etc. Then, a method of communication (e.g., based on one or more recommended communication parameters) to recommend for establishing a new communication is determined, as shown in step 307.

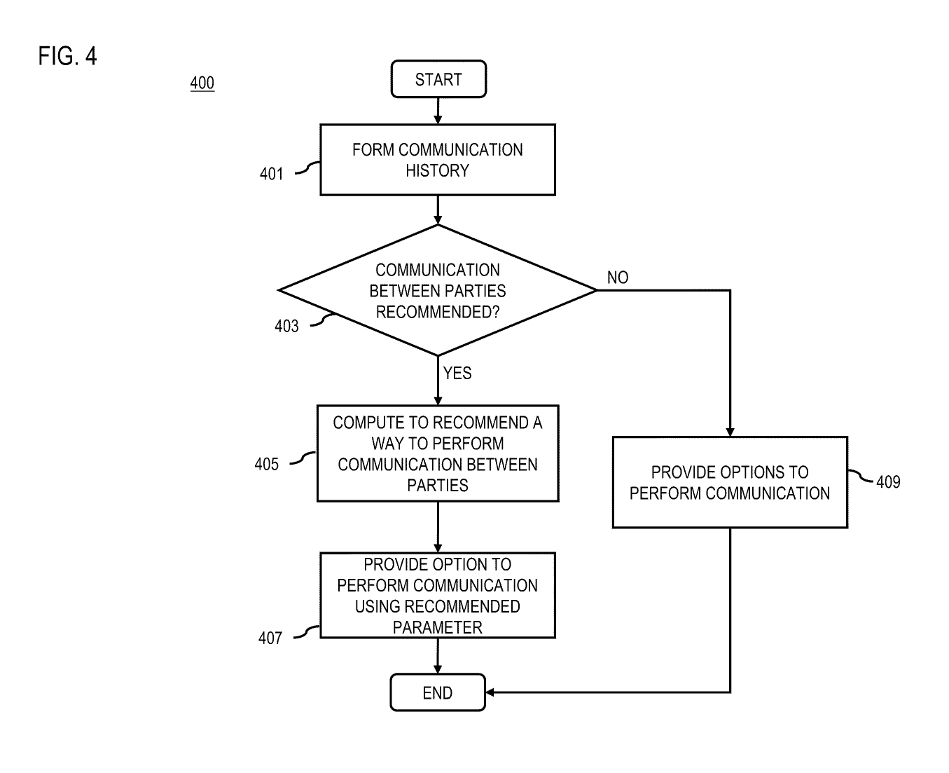

In order to recommend the communication parameter, a frequency and success rate of each of the communication parameters are determined, and the communication parameter or set of parameters that are most desirable (e.g., associated with the highest success rate) is recommended. For example, if the communication parameter considered is a communication type (e.g., a phone call, a text message, an e-mail), the frequency and success rate for each communication type is determined to recommend the best method to communicate with the party. As another example, if a time is considered as the communication parameter, the frequency and the success rate for each time frame may be determined, in order to recommend the best time to communicate with the party. The process for recommending one or more communication parameters are described in greater detail with respect to the process 400 of FIG. 4 below. Once the communication parameter recommendations are determined, the communication history is displayed, as shown in step 309. When displaying the communication history, any of the collected information may be displayed to provide detailed information about each communication session. Further, the recommended parameter for establishing the new communication may be displayed along with the communication history.

FIG. 4 is a flowchart of a process for recommending a communication parameter, according to one embodiment. In one embodiment, the communication widget 107 performs the process 400 and is implemented in, for instance, a chip set including a processor and a memory as shown FIG. 10. In step 401, the communication widget 107 forms a communication history between the communicating parties, and aggregates information related to the communication history. In step 403, the communication widget 107 determines whether a method of communication and/or any other communication parameter between the parties should be recommended, which may be determined based on various factors. For example, the communication widget 107 may be configured such that if a predetermined number of total unsuccessful communication sessions has been reached, then the communication widget 107 may recommend communication between the parties. In another example, a predetermined number of consecutive unsuccessful communication sessions may be considered to determine whether to recommend communication. The successfulness of the communication may be determined by considering whether the communication initiated by one party has been responded to by the other party. For example, the communication may be considered successful if a phone call is answered or an e-mail is replied within a predetermined time limit (e.g. 10 hours). If the phone call is not answered, the phone call is flagged as unsuccessful. However, if the phone call is not answered and the caller left a voice mail, and the party responds by calling back, then the initial phone call by the caller may be unflagged and thus may be no longer treated as unsuccessful.

If a method of communication between the parties is not to be recommended, then the communication widget 107 may provide available options to perform a communication session, and does not provide specific recommendations of communication parameters for establishing a new communication session, as shown in step 409. However, if a method of communication between the parties is to be recommended, then the communication widget 107 considers the collected communication history and various communication parameters contained therein to recommend one or more communication parameters for establishing a new communication session, as shown in step 405. In this invention, the aggregated communication history may be a communication history between the device (e.g. UE 101a) and another device (e.g. UE 101b). However, the aggregated communication history may involve more than two devices. For example, the aggregated communication history may be the communication history between the device (e.g. UE 101a) and a group of other devices (e.g. UE 101b-UE 101n) or a three-way communication history among three devices (e.g. UE 101a, UE 101b and UE 101c). Additionally, the communication history may be associated with individual or groups users of the devices (e.g., UEs 101a-101n) rather than the devices themselves. In this way, if a user communicates using several devices, the communication widget can still provide a comprehensive communication history.

As discussed previously, the communication parameters may include communication type (i.e., form of communication), communication address, location, time, status, schedule, subject, communication party, etc. or any combination thereof. For example, when considering the communication type as a parameter, if more successful communication sessions were established using e-mail than any other communication type, e-mail is suggested as a recommended parameter. In an example of considering the communication address, if the other party is reached more successfully via a work phone number than a home phone number, the work phone number is suggested as a recommended parameter. If these two parameters are used in combination as a criterion, then the communication widget 107 may find work e-mail address the most successful and recommended method to communicate with the party over communicating via, for instance, a work telephone number, a home telephone number, and a personal e-mail address. In an example with respect to location as a communication parameter, if a communication is most successful at a work location than at a home location, then the contact at a work location is recommended. In certain embodiments, the UE 101 may be linked with a global positioning system (GPS) device that can determine the location of the UE 101 when a communication session is initiated with the UE 101. Further, when the time of the communication is considered as a criterion, for example, the most successful time to communicate with the party may be around lunch time between 12:00 PM and 1:00 PM, and this time would be recommended. The time of the day may be divided by hour, or may be divided by schedule (e.g., work hours of 9:00 AM to 5:00 PM, lunch time of 12:00 PM to 1:00 PM, after work hours of 5:00 PM to 12:00 AM, sleep hours of 12:00 AM to 7:00 PM, etc.). Also, a status may be considered as a parameter, wherein the status may be set in the UE 101 or in a profile of a social networking service such as Facebook, Twitter and MySpace. For example, if the communication is most successful when the status is set as “available” rather than “busy,” then communicating when the status is set as “available” is recommended. Further, user's schedule may be used such that any planned event in the user's schedule is monitored at every communication session, for example. Further, the subject of each communication session and a name or a category of the communication party may also be considered as parameters.

After one or more communication parameters to recommend for establishing a new communication session are determined, an option is provided to perform communication using the recommended parameter, as shown in step 407. This option may be displayed on a screen of the UE 101, and may also show a name of the party to whom the communication will be made.

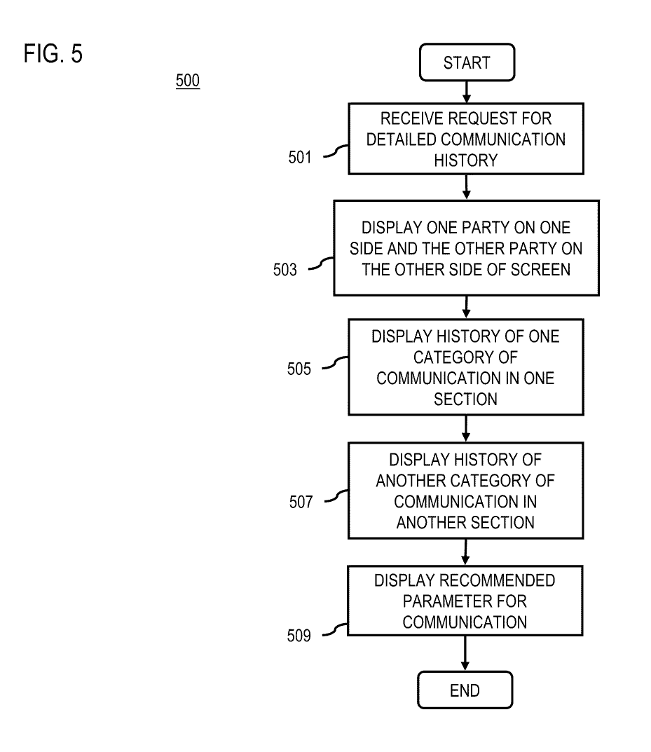

FIG. 5 is a flowchart of a process for displaying a communication history and other related information on a screen, according to one embodiment. In one embodiment, the communication widget 107 performs the process 500 and is implemented in, for instance, a chip set including a processor and a memory as shown FIG. 10. In step 501, the communication widget 107 receives a request for presentation of a detailed communication history between communicating parties. In step 503, the information about one party is displayed on one side and the information about the other party is displayed on the other side of the screen. The information about each party may include the party's name, location, photo, status, etc. In step 505, the communication history of one category of communication is displayed in one section of the screen. This category may be further divided and displayed in separate sections, each section belonging to the corresponding party. In step 507, the communication history of another category of communication is displayed in another section of the screen. This category may also be further divided and displayed in separate sections, each section belonging to the corresponding party. The category of the communication may also be divided into a private communication and public communication. Private communication includes communicating information in a way such that the information is not available to the parties other than a specific sending party and a receiving party. The private communication may include telephone call to a specific party, an e-mail, a text message, etc. In contrast, public communication includes communication of information that may be visible to the general public or selected members of the public. The public communication may include communication via social networking services, wherein a user profile, a status or messages posted on a profile page may be available to public or selected members of the public such as friends. Other forms of public communication include forum postings, blogs entries, public webpages, etc. Further, the user interface of the communication widget 107 may be set such that each section is shown as portions of a three dimensional object, in order to help the user visualize the information more effectively. For example, the user interface may display private communications in one portion of the three dimensional object and public communication in another portion of the object. Additionally, in step 509, any recommended communication parameters for establishing a new communication session are displayed in yet another section of the user interface or screen.

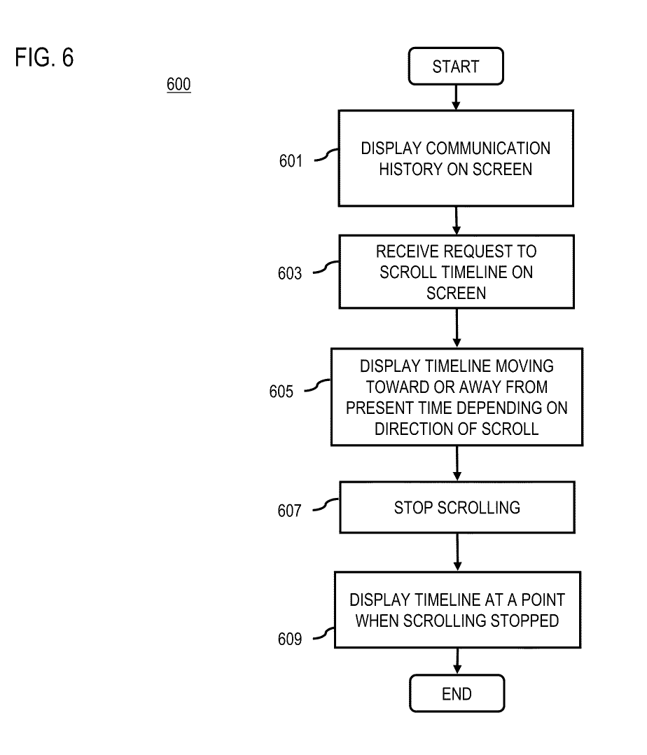

FIG. 6 is a flowchart of a process for scrolling a timeline of a communication history on a screen, according to one embodiment. In one embodiment, the communication widget 107 performs the process 600 and is implemented in, for instance, a chip set including a processor and a memory as shown FIG. 10. In step 601, the communication widget 107 displays a communication history along a timeline showing when each communication session occurred. In step 603, a request to scroll the timeline on the screen is received. The request may be made by pressing a button or turning a knob on the UE 101, or by touching a portion of a touch screen on the UE 101. In step 605, the communication widget 107 displays the timeline moving toward or away from the present time depending on the direction of scroll. For example, if the direction of the scroll is towards the direction of the past, then the timeline on the screen moves away from the present time. If the direction of the scroll is towards the direction of the present time, then the timeline on the screen moves toward the present time. This scrolling feature is advantageous particularly in a device that has a small screen and thus has a limited space to display the communication history. Then, the timeline of the communication history can be scrolled to reveal portions of the history that are not currently shown on the screen due to the size of the screen. When the scrolling stops in step 607, the timeline stops moving and the timeline at a point when the scrolling stopped is displayed, as shown in step 609.

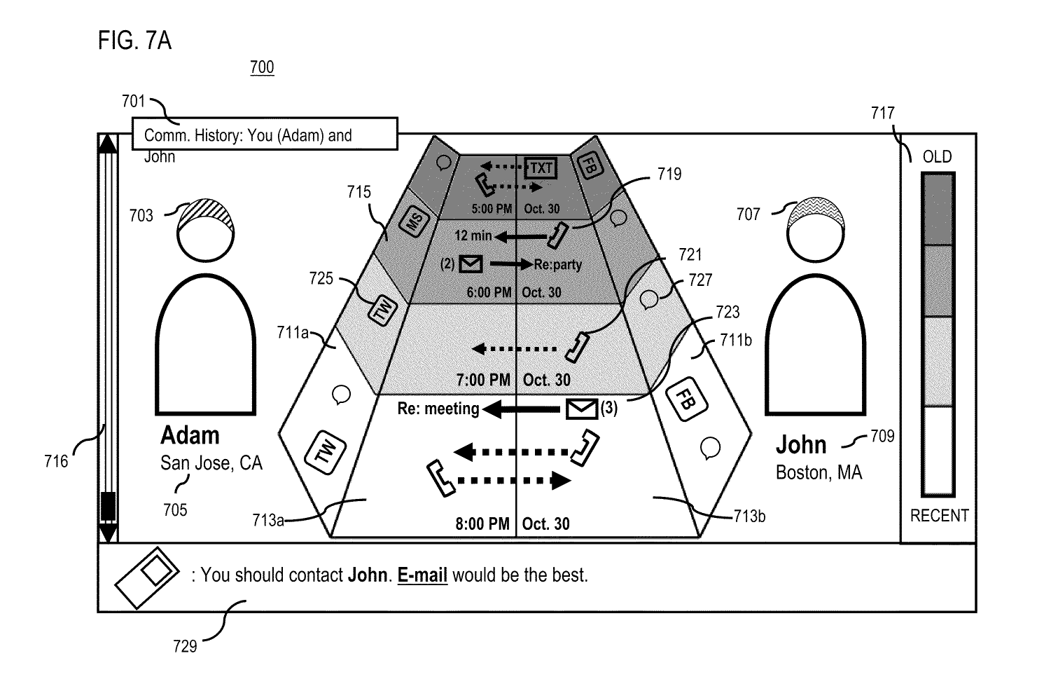

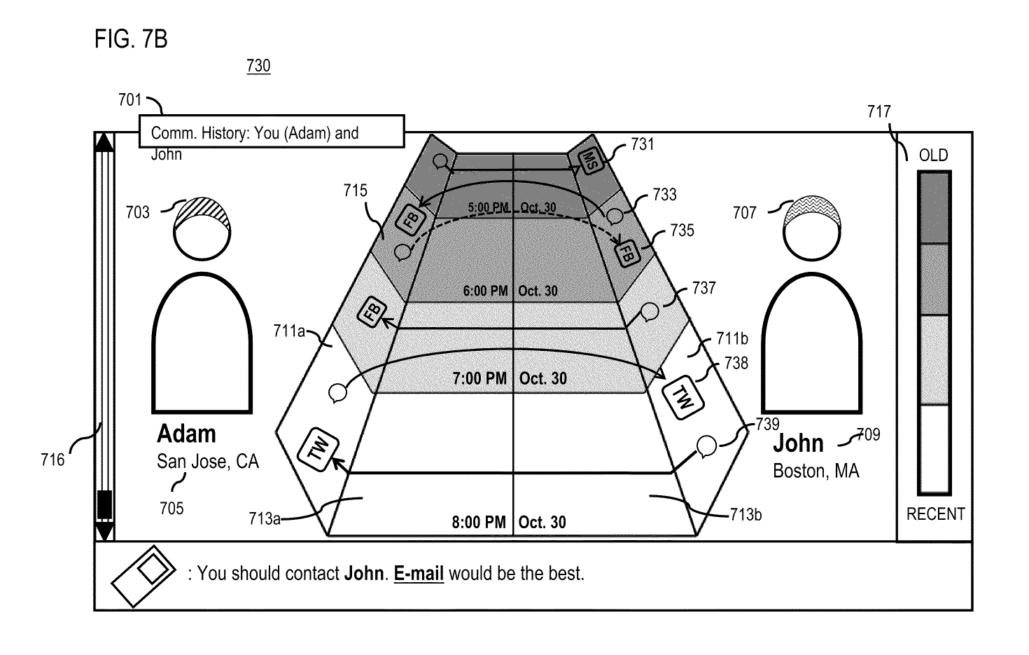

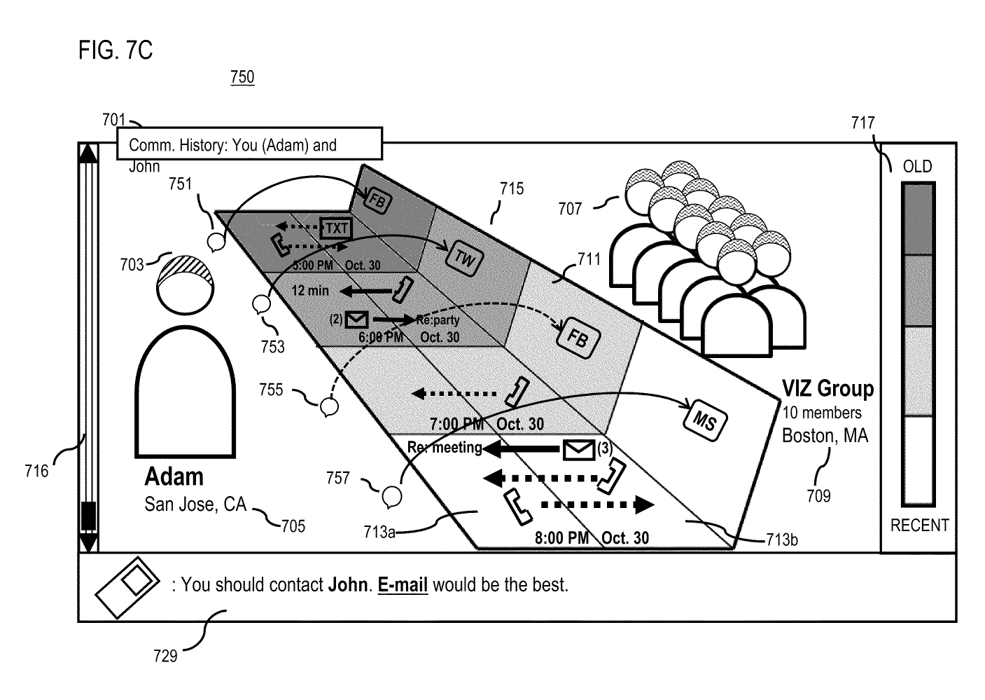

FIG. 7A is a diagram of a user interface utilized in the processes of FIG. 3, according to one embodiment. This user interface may be displayed on a screen of the UE 101 using the communication widget 107. The user interface has a title box 701 showing that what is being displayed is a communication history between a party (e.g. Adam) of the UE 101 and another party (e.g. John). User interface element 703 is a profile picture of the party of the UE 101, which may be a photograph of a user or any other picture uploaded to the UE 101. User interface element 705 displays a name of the party of the UE 101 and may also display information related to the party such as a location of the party (e.g. San Jose, Calif.). User interface element 707 is a profile picture of the external party, which may be a photograph of the external party or any other picture uploaded to the UE 101. User interface element 709 displays a name of the external party and may also display information related to the external party such as a location of the party (e.g. Boston, Mass.). A public section 711 and a private section 713 define a three dimensional section or channel to display a timeline 715, wherein the public section 711 shows sidewalls to display public communication and the private section 713 shows a floor to display private communication. In this embodiment, 711a displays the public communication performed by the party of the UE 101, and 711b displays the public communication performed by the external party. Further, 713a displays the private communication initiated by the party of the UE 101, and 713b displays the private communication initiated by the external party. Thus, in this embodiment, the party of the UE 101 and its communication are located on the left side and the external party and its communication are located on the right side. With the three-dimensional display of public and private communications, a user can easily distinguish between the public communication and the private communication by each party. In addition, the timeline 715 may be scrolled to display different portions of the time line, using the scroll 716.

Further, user interface element 717 shows a color map of the timeline 715, wherein a lighter color means a more recent time. In the timeline 715, details of communication may be shown. The timeline 715 shows specific times (e.g., 7:00 PM Oct. 30) for corresponding locations in the timeline 715. Further, as shown in FIG. 7, the private section 713 shows communication types such as phone, e-mail and text message in pictures for easy recognition by a user. User interface element 719 shows that a telephone call was made from John sometime between 5:00 pm and 6:00 PM on October 30^{th}. As shown in 719, when a telephone call is made and answered, a solid line is shown to represent that the telephone communication was successful, and the total duration of the telephone call (e.g. 12 min) is displayed. As shown by user interface element 721, if the telephone call is made but is not answered, then a dashed line is shown to represent that the telephone communication was unsuccessful. In user interface element 723 showing an e-mail thread, when an e-mail is sent, a title or subject of the e-mail is displayed to represent the thread in the timeline 715. For example, user interface element 723 depicts an e-mail thread with the subject “Re: meeting” that groups three e-mails that have been exchanged under the subject. In this example, the number of e-mails in the thread is indicated by the number “3” displayed next to the email-icon. The location of the e-mail thread on the timeline 715 may be determined based on the time of the latest e-mail under this thread. In addition or alternatively, the thread may be displayed at a time for any of the other e-mails in the thread or at multiple times on the timeline 715 (e.g., at points corresponding to one or more of the other e-mails in the thread). Also, as shown by user interface element 723, a solid line is shown to represent that the e-mail communication was successful (i.e., the recipient opened the e-mail or responded to the e-mail). In one example, a dashed line may be shown to represent that the e-mail communication was unsuccessful (i.e., the recipient has not opened the e-mail or has not responded to the e-mail), and to turn the dashed line to a solid line when the e-mail is opened. The timeline 715 also shows information about public communication. For example, user interface element 725 shows that a Twitter status was updated sometime between 6:00 pm and 7:00 PM on October 30^{th}. Other types of public communications are shown as FB for Facebook and MS for MySpace, in this embodiment. User interface element 729 shows an initiation of a public communication and is paired with a public communication such as Facebook, MySpace, Twitter, etc. Further, the recommendation window 729 shows a recommendation to contact John and a recommended way to contact John (e.g. e-mail).

FIG. 7B is a diagram of a user interface utilized in the processes of FIG. 3, showing only social networking services, according to one embodiment. This user interface may be displayed on a screen of the UE 101 using the communication widget 107. For the purpose of demonstration of communication using social networking services, private communication in the private section 713 is not shown in FIG. 7B. User interface elements 701-717 in FIG. 7B are equivalent to user interface elements 701-717 of FIG. 7A. User interface element 731 shows a direct message sent from Adam to John using MySpace. Because the direct message is not public communication but is shown only to Adam and John, the arrow passes the private section 713 to reach the MySpace icon. User interface element 733 illustrates that John commented on Adam's Facebook status by showing a solid arch-shaped arrow arched over the private section 713, instead of passing through the private section 713. The arrow arched over the private section 713 means that this communication is not private communication but rather public communication. Because the Facebook status can be seen by everyone or selected group of users on Facebook, the status is not private communication between John and Adam. Similarly, in user interface element 735, a dotted arched arrow is used to show that Adam “likes” John's status. Adam's “liking” of John's status is also not private communication, and thus an arched arrow is used. On the contrary, when John sent a Facebook direct message to Adam, as shown by user interface element 733, this arrow passes through the private section 713 because this is private communication that can be seen by only Adam and John. In a case of Twitter, when Adam replies to John's “tweet,” as shown by user interface element 738, an arched arrow is used because this “tweet” is available to a selected group of users. However, in 739, when John sends a direct message to Adam using Twitter, the arrow passes through the private section 713 because this message can be seen only by Adam and John.

FIG. 7C is a diagram of a user interface utilized in the processes of FIG. 3, in a case when an individual communicates with a group, according to one embodiment. This user interface may be displayed on a screen of the UE 101 using the communication widget 107. FIG. 7C shows a rotated view of the three dimensional representation of the time line 715, which is different from the three dimensional representation shown in FIG. 7A. This view may be obtained automatically or by a user manually rotating the view of the three dimensional representation of the timeline 715. As shown, user interface elements 701-717 in FIG. 7C are equivalent to user interface elements 701-717 of FIG. 7A, with slight differences. The public section 711 in FIG. 7C is available only for the group VIZ Group, and is not available for the individual Adam. When an individual communicates with a group, the individual's status or the individual's twitter may not be important to the group. Thus, in this case, Adam's Facebook status or Twitter tweet is not shown. However, the individual Adam can also comment on Facebook status or Twitter tweet of the group VIZ group, as shown by user interface elements 751 and 753, respectively. Further, as shown by user interface element 755, the individual Adam may “like” the Facebook status of the group VIZ group. The individual Adam may also comment on MySpace of the group VIZ group, as shown in 747. Additionally, 709 may show the name of the group, the location of the group, and the number of members in the group.

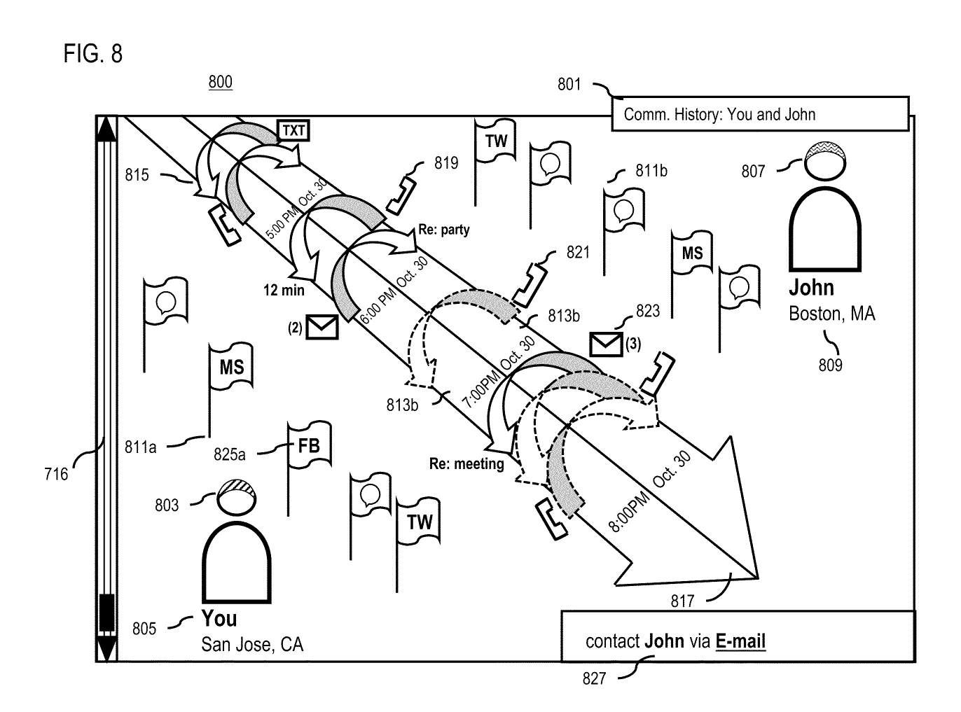

FIG. 8 is a diagram of user interfaces utilized in the processes of FIG. 3, according to another embodiment. This user interface may be displayed on a screen of the UE 101 using the communication widget 107. User interface elements 701-715 and 719-729 in FIG. 8 are equivalent to user interface elements 701-715 and 719-729 of FIG. 7A. FIG. 8 shows a different visualization than FIG. 7A. As shown, flags represent communications in the public section 811, and large arrows are used to represent communication in the private section 813. Further, the timeline 815 is displayed in a diagonal direction, and thus this embodiment may be able to display a longer timeline than the timeline 715 in FIG. 7A.

The processes described herein for presenting a communication history may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

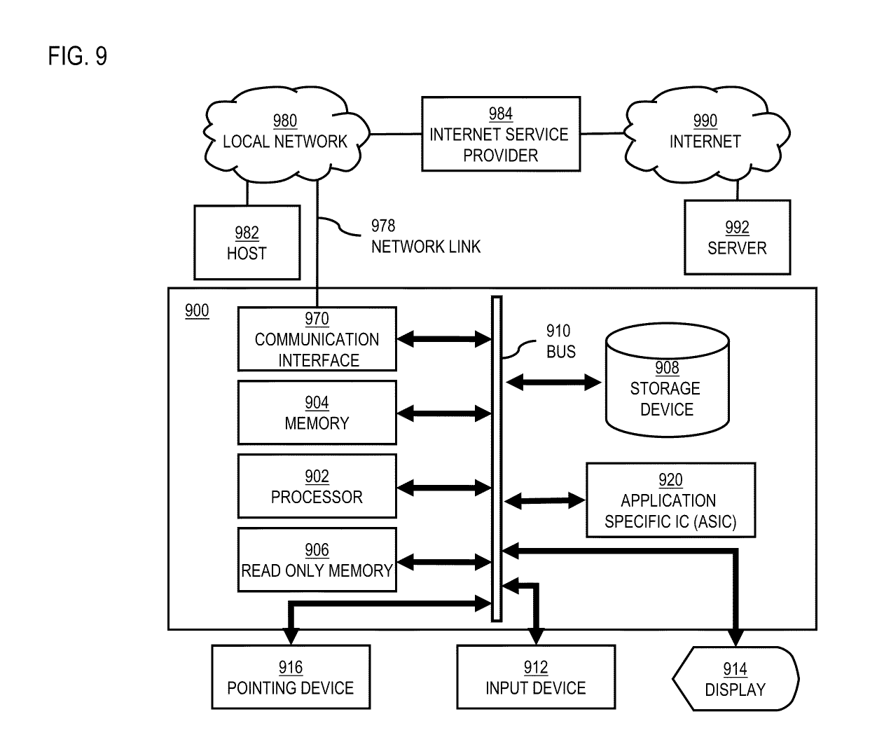

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to present a communication history as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of presenting a communication history.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to presenting a communication history. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for presenting a communication history. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for presenting a communication history, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for presenting a communication history.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to present a communication history as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of presenting a communication history.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to presenting a communication history. The memory 1005 also stores the data associated with or generated by the execution of the inventive steps.

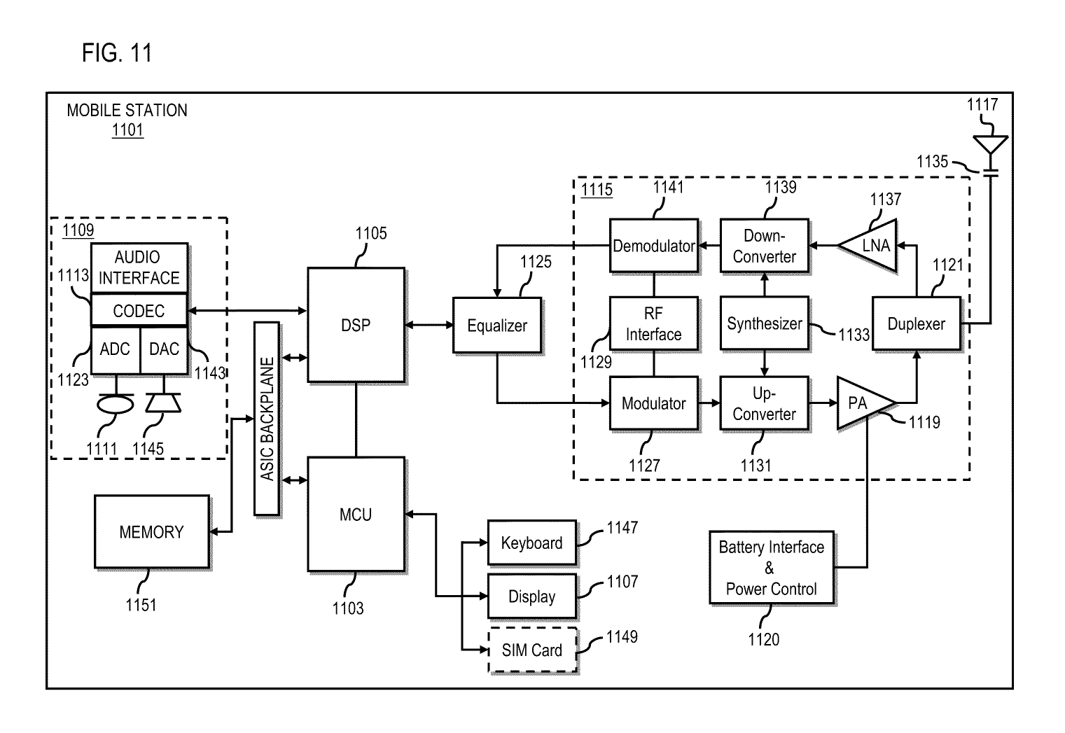

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of presenting a communication history. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of presenting a communication history. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to present a communication history. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting context information on one or more communication sessions between a first party and a second party from a plurality of applications, services, devices, or a combination thereof;
aggregating the context information into a communication history;
identifying one or more communication parameters in the context information, wherein the communication parameters relate to performing the communication sessions; and
determining a frequency or a success rate of each of the identified communication parameters in the communication history.

2. A method of claim 1, further comprising:
providing one or more recommended communication parameters for establishing a new communication session based, at least in part, on the frequency or the success rate determined for each of the identified communication parameters.

3. A method of claim of 2, wherein the communication parameters include communication type, communication address, location, time, status, schedule, subject, communication party, or a combination thereof.

4. A method of claim 1, wherein in the success rate of each identified communication parameter is based on whether the second party responds to a communication session initiated by the first party using the corresponding identified communication parameter.

5. A method of claim 2, further comprising:
receiving a request to present the communication history;
causing, at least in part, presentation of the communication history and the recommended communication parameters in a user interface, the user interface including a timeline representation of the one or more communication sessions in the communication history.

6. A method of claim 5, wherein the timeline representation is scrollable to present various portions of the communication history in time, and wherein the timeline representation presents, at least in part, the identified communication parameters and a successfulness of each of the identified communication parameters for each communication session in the communication history.

7. A method of claim 5, wherein the timeline representation is divided into a plurality of sections, each section corresponding to a communication parameter, a successfulness of the communication session, a communication address, a communication party, a time, a location, a status, a subject, or a combination thereof.

8. A method of claim 5, wherein the user interface is rendered as a three-dimensional visualization including animation.

9. An apparatus comprising:
at least one processor; and
at least one memory including computer program code,
the at least one memory and the computer program code configured to, with the at least one processor, cause the apparatus to perform at least the following,
collect context information on one or more communication sessions between a first party and a second party from a plurality of applications, services, devices, or a combination thereof;
aggregate the context information into a communication history;
identify one or more communication parameters in the context information, wherein the communication parameters relate to performing the communication sessions; and
determine a frequency or a success rate of each of the identified communication parameters in the communication history.

10. An apparatus of claim 9, wherein the apparatus is further caused to:
provide one or more recommended a communication parameter for establishing a new communication session based, at least in part on the frequency or the success rate determined for each of the identified communication parameters.

11. An apparatus of claim of 10, wherein the communication parameters include communication type, communication address, location, time, status, schedule, subject, communication party, or a combination thereof.

12. An apparatus of claim 1, wherein in the success rate of each identified communication parameter is based on whether the second party responds to a communication session initiated by the first party using the corresponding identified communication parameter.

13. An apparatus of claim 10, wherein the apparatus is further caused to:
receive a request to present the communication history;
cause, at least in part, presentation of the communication history and the recommended communication parameter in a user interface, the user interface including a timeline representation of the one or more communication sessions in the communication history.

14. An apparatus of claim 13, wherein the timeline representation is scrollable to present various portions of the communication history in time, and wherein the timeline representation presents, at least in part, the identified communication parameters and a successfulness of each of the identified communication parameters for each communication session in the communication history.

15. An apparatus of claim 13, wherein the timeline representation is divided into a plurality of sections, each section corresponding to a communication parameter, a successfulness of the communication session, a communication address, a communication party, a time, a location, a status, a subject, or a combination thereof.

16. An apparatus of claim 13, wherein the user interface is rendered as a three-dimensional visualization including animation.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
collecting context information on one or more communication sessions between a first party and a second party from a plurality of applications, services, devices, or a combination thereof;
aggregating the context information into a communication history;
identifying one or more communication parameters in the context information, wherein the communication parameters relate to performing the communication sessions; and
determining a frequency or a success rate of each of the identified communication parameters in the communication history.

19. A computer-readable storage medium of claim 18, wherein the apparatus is further caused to perform:
providing one or more recommended a communication parameter for establishing a new communication session based, at least in part, on the frequency or the success rate determined for each of the identified communication parameters.

20. A computer-readable storage medium of claim 19, wherein the apparatus is further caused to perform:
receiving a request to present the communication history;
causing, at least in part, presentation of the communication history and the recommended communication parameter in a user interface, the user interface including a timeline representation of the one or more communication sessions in the communication history.
